(19) United States
(12) Patent Application Publication
(10) Pub. No.: US 2019/0318231 A1
(43) Pub. Date: Oct. 17, 2019

(54) METHOD FOR ACCELERATION OF A NEURAL NETWORK MODEL OF AN ELECTRONIC EUQIPMENT AND A DEVICE THEREOF RELATED APPLICTION INFORMATION

(71) Applicant: Hangzhou Flyslice Technologies Co., Ltd., Hangzhou (CN)

(72) Inventors: Wenhua WANG, Hangzhou (CN); Ailian CHENG, Hangzhou (CN)

(21) Appl. No.: 16/404,232

(22) Filed: May 6, 2019

(30) Foreign Application Priority Data
Apr. 11, 2018 (CN) 201810322936.4

(51) Int. Cl. G06N 3/063; G06N 3/04; G06N 3/08

(52) U.S. Cl. CPC G06N 3/063; G06N 3/08; G06N 3/04

(57) ABSTRACT

A method is provided for hardware acceleration of a neural network model of an electronic equipment and a device thereof. The method includes: obtaining data to be identified and a configuration parameter for the neural network model of the first electronic equipment; proceeding the hardware acceleration of a convolution calculation matched with the neural network model of the first electronic equipment for the data to be identified according to the configuration parameter, and generating a convolution result of the neural network model of the first electronic equipment for the data to be identified. The invention can support a neural network model established by various open source development environments, and also support a user-defined neural network model; when the algorithm of the neural network model is updated, only the parameters of the first electronic device need to be reconfigured without changing the hardware.

### RELATED APPLICATION INFORMATION

This application claims the benefit of CN 201810322936.4, filed on Apr. 11, 2018, the disclosures of which are incorporated herein by reference in their entirety.

### FIELD OF THE DISCLOSURE

The present disclosure relates generally to a technology of deep learning in artificial intelligence field, and more particularly to a method for hardware acceleration of a neural network model of a first electronic equipment and a device thereof, and a method for an auxiliary acceleration of a neural network model of a second electronic equipment.

### BACKGROUND OF THE DISCLOSURE

In the past few decades, the computing performance of CPU has been increasing rapidly. However, due to the limitations of physical laws such as power consumption, interconnect latency, and design complexity, the computing capacity of CPU has almost approached the physical limit by 2014, with CPU's main frequency around 3.6 GHz. In this case, heterogeneous acceleration becomes one of the ways to achieve higher computing performance. The so-called heterogeneous acceleration (Hybrid Acceleration) refers to the integration of different acceleration equipment on the basis of CPU to achieve calculation acceleration and higher performance. Common acceleration equipment may include GPU, FPGA and ASIC.

Deep learning is an emerging field in machine learning research. The motivation is to build and simulate neural networks of human brain in terms of analysis and learning. It mimics the working mechanism of human brain to interpret data such as images, sounds and texts. In recent years, with the rise of artificial intelligence, deep learning technique has been widely used in applications including image recognition, speech analysis, natural language processing and related fields. Deep learning is built on massive data and supercomputing power, and has a great requirement for computing capacity. Therefore, how to use heterogeneous acceleration to implement an efficient neural network processing system has attracted extensive attention from academia and industry.

In the prior art, most implementations for neural network processing system with heterogeneous acceleration, optimize the design from hardware structure to software layer and deeply customize to characteristics of the specified neural network model. It is popular because this method always achieves better computing performance. However, as algorithms for neural network model update frequently, the corresponding solutions for hardware acceleration have to be re-designed for each update. Besides, there are many frameworks and developing environments for neural network model, such as Tensorflow, Torch, Caffe, Theano, Mxnet, Keras, etc. It must be a tough work for a deeply customized acceleration solution to migrate between these diverse frameworks. Since the hardware development period of an acceleration equipment is long, generally a few months or more, the update speed of a hardware solution is much lower than that of the corresponding neural network algorithm, which greatly hinders the wide applications of acceleration equipment.

Therefore, there is an urgent need for hardware acceleration method and equipment, which has better adaptability for changeable algorithms and is more versatile to different neural network frameworks.

The statements in this section merely provide background information related to the present disclosure and may not constitute prior art.

### SUMMARY

The object of this invention is to provide a method for acceleration of a neural network and a device thereof, with small change and strong versatility, when an algorithm of a neural network model changes.

To resolve the above problems, one aspect of this invention is to provide a method for hardware acceleration of a neural network model of a first electronic equipment. The method may include: obtaining data to be identified and a configuration parameter for the neural network model of the first electronic equipment; proceeding the hardware acceleration of a convolution calculation matched with the neural network model of the first electronic equipment for the data to be identified according to the configuration parameter, and generating a convolution result of the neural network model of the first electronic equipment for the data to be identified; and proceeding the hardware acceleration of a function calculation for the convolution result by calling one or more function modules which match with the neural network model of the first electronic equipment from at least one function module which preset according to the configuration parameter, and generating a recognition result of the neural network model of the first electronic equipment for the data to be identified.

The configuration parameter may include: a weight parameter of the neural network model of the first electronic equipment, a convolution calculation parameter, and one or more of called function parameters which is required; the weight parameter is generated by rearranging an original weight parameter of the neural network model of the first electronic equipment based on a format needed by the first electronic equipment; the convolution calculation parameter comprises: specification of the data to be identified, quantity of a convolution kernel, size of the convolution kernel, step size of the convolution calculation, and one or more of number of layers of the neural network model; called function parameters which is required comprise: a function name, a function parameter and a calling sequence, which is called by the neural network model of the first electronic equipment according to requirement.

The hardware acceleration of the function calculation for the convolution result may include: connecting one or more function modules by Bypass according to the configuration parameter; inputting the convolution result into one or more function modules which is connected by Bypass, proceeding the hardware acceleration by one or more function modules in order and outputting a result.

At least one function module which preset may include one or more of the following functions: BatchNorm, Scale, Eltwise, ReLU, Sigmoid, Tanh, Pooling, max pooling, mean pooling, root mean square pooling, FC(Full Connection calculation), and Softmax.

Obtaining the data to be identified and the configuration parameter of the neural network model of the first electronic equipment may include: reading the data to be identified and the configuration parameter of the neural network model of the first electronic equipment from an external memory, and writing the data to be identified and the configuration parameter of the neural network model of the first electronic equipment which is read into a local memory.

When the data to be identified is reading and writing, each separate data file is read and written only once.

If specification of the data to be identified which is read is M*N*K, according to a split method of M*(N1+N2)*(K1+K2) the processing data is split into some small three-dimensional matrix at the time of writing; for a picture file, M is a width of a picture, N is a height of the picture, K is number of channels of the picture; K1+K2=K, N1+N2=N.

Another aspect of this invention is to provide a device for hardware acceleration of a first electronic equipment. The device may include: an acquisition module, used for obtaining data to be identified and a configuration parameter of the neural network model of the first electronic equipment; a convolution calculation module, used for proceeding the hardware acceleration of a convolution calculation matched with the neural network model of the first electronic equipment for the data to be identified according to the configuration parameter, and generating a convolution result of the neural network model of the first electronic equipment for the data to be identified;; and a function calculation module, used for proceeding the hardware acceleration of a function calculation for the convolution result by calling one or more function modules which match with the neural network model of the first electronic equipment from at least one function module which preset according to the configuration parameter, and generating a recognition result of the neural network model of the first electronic equipment for the data to be identified.

The configuration parameter may include: a weight parameter of the neural network model of the first electronic equipment, a convolution calculation parameter, and one or more of called function parameters which is required; the weight parameter is generated by rearranging an original weight parameter of the neural network model of the first electronic equipment based on a format needed by the first electronic equipment; the convolution calculation parameter comprises: specification of the data to be identified, quantity of a convolution kernel, size of the convolution kernel, step size of the convolution calculation, and one or more of number of layers of the neural network model; called function parameters which is required comprise: a function name, a function parameter and a calling sequence, which is called by the neural network model of the first electronic equipment according to requirement.

The function calculation module may include a function skip module and at least one function module.

Each function module is used for implementing a function calculation of a specific function; the function skip module is used for connecting one or more function modules by Bypass according to the configuration parameter; the convolution result is inputted into one or more function modules which are connected by Bypass, proceeded by one or more function modules with hardware acceleration in order and outputted as a result.

At least one function module which preset may include one or more of the following functions: BatchNorm, Scale, Eltwise, ReLU, Sigmoid, or Tanh, Pooling, max pooling, mean pooling, root mean square pooling, FC, and Softmax.

A read and write control module is used for reading the data to be identified and the configuration parameter of the neural network model of the first electronic equipment from an external memory, and writing the data to be identified and the configuration parameter of the neural network model of the first electronic equipment which is read into a local memory.

The read and write control module is used to implement that, when the data to be identified is reading and writing, each separate data file is read and written only once.

If specification of the data to be identified which is read by the read and write control module is M*N*K, according to a split method of M*(N1+N2)*(K1+K2) the data to be identified is split into some small three-dimensional matrix when the read and write control module is writing; for a picture file, M is a width of a picture, N is a height of the picture, K is number of channels of the picture; K1+K2=K, N1+N2=N.

In another aspect of this invention, in order that the method for the hardware acceleration of the first electronic equipment can be compatible with various open source environments and a user-defined neural network model, the present is to provide a method for an auxiliary acceleration of a neural network model of a second electronic equipment. The method may include: extracting a topology structure and a parameter for each layer of the neural network model of the first electronic equipment which is trained from an open source framework, and based on the topology structure and the parameter for each layer which is extracted, generating the configuration parameter of the first electronic equipment which is used in the method for the hardware acceleration of the neural network model of the first electronic equipment according to any one of the foregoing claims; and providing the configuration parameter to the first electronic equipment.

The method for the auxiliary acceleration of the second electronic device is implemented by a software program, which comprises two layers. One is a network topology extraction layer and the other is a driver layer.

According to topology characteristics of convolution neural network in deep learning, for a hardware design, a general topology structure is designed and the corresponding universal design is made for each sub-module. Thereby, support for various convolution network types is obtained

The above technical solution of this invention has the following beneficial effects: This invention can not only support neural network models established by various open source development frameworks, but also support user-defined neural network models. With the present invention, when algorithms in neural network models are changed or updated, only parameters of the first electronic equipment need to be reconfigured, and hardware design of the first electronic equipment remains unchanged.

This invention can not only implement the hardware acceleration of open source models, such as LeNet, AlexNet, GoogLeNet, VGG, ResNet, SSD, etc., but also support for implementing non-generic models, like network models combined by Resnet18 and SSD300.

The method provided in this invention does not need to change an underlying circuit design of a hardware accelerator, and just need to know the topology structure of the convolution neural network and the parameter for each layer, then the hardware acceleration can be obtained for the corresponding network model. This invention can adopt a universal scheme to support the hardware acceleration for various convolution networks, thereby, can eliminate redesign for the hardware acceleration, and can support users to modify algorithms and fast iterations, greatly facilitating users to use.

This invention can be used not only for FPGA design, but also for ASIC design. As a universal circuit is adopted, various convolution neural networks can be supported, and it is feasible to instantiate it in an FPGA design or an ASIC design.

### BRIEF DESCRIPTION OF THE DRAWINGS

FIG. 1 shows a flowchart of a method for hardware acceleration of a neural network model of a first electronic equipment.

FIG. 2 shows a block diagram of a device for hardware acceleration of a neural network model of a first electronic equipment.

FIG. 3 shows a schematic diagram of an embodiment of the device for the hardware acceleration of the neural network model of the first electronic equipment and an auxiliary software program of a neural network model of a second electronic equipment.

FIG. 4 shows an internal function diagram for an acceleration equipment in FIG. 3.

FIG. 5 shows a diagram for a network structure of AlexNet.

The drawings described herein are for illustrative purposes only of exemplary embodiments and not all possible implementations, and are not intended to limit the scope of the present disclosure. Corresponding reference numerals indicate corresponding parts throughout the several views of the drawings

### DETAILED DESCRIPTION

The following description of the preferred embodiments is merely exemplary in nature and is in no way intended to limit the invention, its application, or uses.

The present invention will be further described in detail below with reference to the specific embodiments thereof and the accompanying drawings. It is to be understood that the description is not intended to limit the scope of the invention.

In the descriptions of the present invention, it is to be noted that the terms “first” and “second” are used for descriptive purpose only and are not to be construed as indicating or implying relative importance.

This invention provides a method for hardware acceleration of a neural network model of a first electronic equipment and a device thereof, also provides a method for an auxiliary acceleration of a neural network model of a second network equipment.

The first electronic equipment refers to an acceleration equipment, including FPGA or ASIC. FPGA is short for Field Programmable Gate Array, and ASIC is short for Application Specific Integrated Circuit. The difference between FPGA and ASIC is that, FPGA can be reprogramed repeatedly, while ASIC cannot be changed in hardware after produced. FPGA is widely used in diverse scenarios at a small quantity because of its flexibility and programmability. ASIC is focused on a specific scenario at a large quantity because of its high performance and low cost. FPGA is more preferable in the cases when users are optimizing the solutions and changing the algorithms frequently.

The second electronic equipment refers to a host computer.

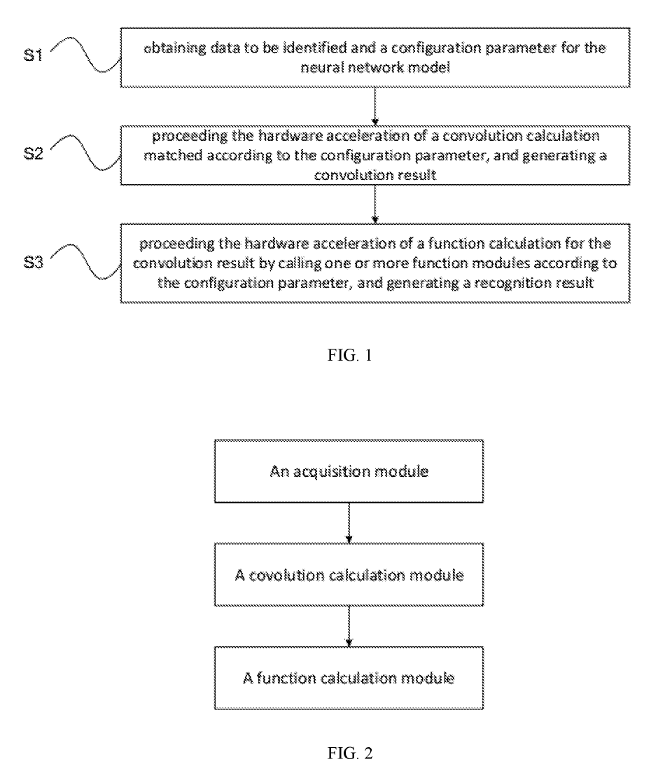

FIG. 1 shows a flowchart of a method for hardware acceleration of a neural network model of a first electronic equipment.

As shown in FIG. 1, a first embodiment of the method for the hardware acceleration of the neural network model of the first electronic equipment comprises the following steps S1-S3:

S1, data to be identified and a configuration parameter for the neural network model of the first electronic equipment is obtained. The data to be identified is data of a picture.

The method provided by this invention can accelerate different application network models, such as: various types of CNN (Convolutional Neural Network), RNN (Recurrent Neural Network, and DNN (Deep Neural Network).

The configuration parameter comprises: a weight parameter of the neural network model of the first electronic equipment, a convolution calculation parameter, and one or more of called function parameters which are required.

The weight parameter is generated by rearranging an original weight parameter of the neural network model of the first electronic equipment based on a format needed by the first electronic equipment. An application of the neural network model is divided into two phases: firstly, a relatively perfect model (as well as a knowledge base) can be obtained by using machine learning with a large amount of trained data; then, the model (and the knowledge base) can be used to process new data, identify it and output the corresponding results. This invention mainly applies the hardware acceleration for the latter stage, and the former stage uses traditional open source frameworks for training in machine learning. The original weight parameter refers to the weight parameter after the completion of the former stage (training), generally refers to the training results of Caffe or Tensorflow. The weight parameter of the training results has a different data format with that required by an acceleration equipment, so it need to split and re-combine the weight parameter to obtain a weight parameter format required by the acceleration equipment.

The convolution calculation parameter comprises: specification of the data to be identified, quantity of a convolution kernel, size of the convolution kernel, step size of the convolution calculation, and one or more of number of layers of the neural network model.

Called function parameters which are required comprise: a function name, a function parameter and a calling sequence, which is called by the neural network model of the first electronic equipment according to requirement. For example, which functions need to be called after a convolution calculation is completed; if Eltwise and ReLU are required, what are parameters of Eltwise, whether to call Eltwise first, or to call ReLU first. It is to be noted that, Function modules can be set in any order when preset in an equipment, but usually have a sequential requirement when called.

S2, the hardware acceleration of a convolution calculation matched with the neural network model of the first electronic equipment is proceeded for the data to be identified according to the configuration parameter, and a convolution result of the neural network model of the first electronic equipment for the data to be identified is generated.

In order to enable the acceleration equipment to support various convolution neural network models in the convolution calculation, specifications of pictures and specifications of convolution kernels can be set by the configuration parameter, such as, specifications of pictures for 224*224*3 and 300*300*3, specifications of convolution kernels for 3*3*3 or 7*7*3. Specifically, for the convolution calculation, specification of the picture data and convolution kernels is extracted from the convolution calculation parameter of the configuration parameter obtained in S1 to proceed the convolution calculation for the picture data.

S3, the hardware acceleration of a function calculation for the convolution result by calling one or more function modules which match with the neural network model of the first electronic equipment from at least one function module which preset is proceeded according to the configuration parameter, and a recognition result of the neural network model of the first electronic equipment for the data to be identified is generated.

In order to enable the acceleration equipment to support various convolution neural network models in the convolution calculation, multiple function modules can be preset. Specifically, the convolution result is calculated by a function which is selected from multiple functions preset and adapted with the configuration parameter according to called function parameters of the configuration parameter obtained in S1, and a calculation result can be obtained.

At least one function which preset comprises one or more of the following functions: BatchNorm, Scale, Eltwise, ReLU, Sigmoid, Tanh, Pooling, max pooling, mean pooling, root mean square pooling, FC, and Softmax.

Names of the above functions are standard descriptions of functions from the open source framework of a convolution neural network in the prior art. The functions themselves are not the inventive points of the present invention. In order to make the public more aware of the functions specified by this invention, they will be briefly described in the following.

BatchNorm proceeds a standard processing for an input signal by subtracting the average value and dividing by the standard deviation, so that the average value of each dimension of the output signal is 0, and the variance is 1, to ensure the trained data and test data of the neural network model with the same probability distribution.

Scale is usually used in conjunction with BatchNorm, which reduces the feature representation of the model due to the normalized preprocessing. Scale corrects the effects of normalization by uniform scaling and translating.

Eltwise is used for proceeding dot product operation, addition operation, subtraction operation, or maximum operation for an element.

ReLU, Sigmoid, and Tanh are used to add nonlinear factors, improve the expression ability of the neural network, and preserve and map the characteristics of the neurons.

Pooling, max pooling, mean pooling, and root mean square pooling collect statistics on the features of different locations by calculating the average (or maximum) of a feature on an area of an image.

FC maps the distributed features extracted by the neural network model to the sample mark space by means of dimensional transformation, and reduces the influence of the feature position on the classification

Softmax is used for mapping the output of multiple neurons into the (0, 1) interval, thereby calculating the probability that each neuron output is in all outputs.

Take Resnet18 as an example, the configuration parameter shows that after the convolution calculation is completed, functions called which are required comprise: BatchNorm, Scale, ReLU, Pooling. The convolution result is calculated by BatchNorm, Scale, ReLU, and Pooling which are selected from multiple functions preset.

Further, in another embodiment of the method for the hardware acceleration of the neural network model of the first electronic equipment, according to S1, obtaining the picture data and the configuration parameter of the neural network model comprise: reading the picture data and the configuration parameter of the neural network model from an external memory(such as, DDR of the first electronic equipment), and writing the picture data and the configuration parameter of the neural network model which is read into a local memory(such as, RAM of the first electronic equipment).

DDR is short for Double Data Rate, DDR should be called strictly DDR SDRAM.DDR is generally called by technicians in the art. SDARM is short for Synchronous Dynamic Random Access Memory.

Further, in another embodiment of the method for the hardware acceleration of the neural network model of the electronic equipment, the hardware acceleration of function calculation for the convolution result comprises: connecting one or more function modules by Bypass according to the configuration parameter in S31; and inputting the convolution result into one or more function modules which are connected by Bypass, proceeding the hardware acceleration by one or more function modules in order and outputting a result in S32.

Bypass is a function which can implement skipping over unused functions.

Bypass has technical effects for skipping over the function which is irrelevant to the configuration parameter in multiple functions, and performing the function which is relevant to the configuration parameter for the convolution result.

In the process of implementing this invention, on the basis of the above embodiments, the inventor found that to ensure performance without loss under the premise of universality, the following three factors need to be considered comprehensively: first, to ensure that the convolution calculation module works at a full load; second, the local storage of acceleration equipment is limited; third, supporting as many different specifications of picture data as possible.

Performance of a convolution calculation module depends on input bandwidth and transfer efficiency. If all picture data which is required and the configuration parameter are preloaded to the local RAM of the acceleration equipment, the convolution calculation module is guaranteed with a full workload. However, the storage space of the local RAM is limited, and it is impossible to cache all the data with any specification, the data which is required has to be continuously read from DDR to fill and update the local RAM in the process of the convolution calculation. In order to make full use of a transmission bandwidth between DDR and the acceleration equipment, frequently accessed data should be cached as much as possible in the local RAM of the acceleration equipment, rather than repeatedly going to DDR to read such data, otherwise it will not only waste DDR bandwidth, but also increase latency and affect performance. Therefore, in the case of limited local storage space of the acceleration equipment, which data is cached, how data is stored, and how data is updated, are critical issues.

To resolve the above problems, this invention has made further improvements on the basis of the first embodiment, when the data to be identified is reading and writing, each separate data file is read and written only once.

Take the picture data as the data to be identified for example, in the process of the convolution calculation, both the picture data and the weight parameter should be read repeatedly; the picture data is relatively large in size, and the weight parameter is small in size but various in kinds. Extracting a region of picture data is expensive, and it is relatively easy to extract the corresponding weight parameter. Therefore, the scheme proposed in this invention is to cache the picture data in the local RAM of the acceleration equipment as much as possible, the picture data is read only once, and the weight parameter can be read several times.

When all the picture data cached is processed, subsequent picture data is read from DDR to the local RAM. This improves the utilization efficiency of DDR bandwidth and makes the convolution calculation module work as full load as possible.

Further, assuming specification of the picture data is M*N*K, because the local RAM resources of the acceleration equipment are limited, picture data of arbitrary size may exceed the local storage space and cannot be read to the local RAM at once. In order to be compatible with different specifications of the picture data, this invention proposes a technical scheme to split N and K at the same time, so that each part of the split data will not exceed the local storage space, and can be stored separately in the local memory. It does not affect the performance of the convolution calculation module, but also achieve universality.

Specifically, this invention makes further improvements on the basis of the first embodiment of the method for the hardware acceleration of the neural network model of the electronic equipment, and proposes the following further technical solutions: the data to be identified and the configuration parameter of the neural network model of the first electronic equipment are read from an external memory, and the data to be identified and the configuration parameter of the neural network model of the first electronic equipment which is read are written into a local memory. If specification of the data to be identified which is read is M*N*K, according to a split method of M*(N1+N2)*(K1+K2) the processing data is spit into some small three-dimensional matrix when the data to be identified is writing.

If the data to be identified is a picture file, M is a width of a picture; such as, M=1000 represents a picture width of 1000 pixels; N is a height of the picture, such as, N=800 represents a picture height of 800 pixels, N1+N2=N. K is number of channels of the picture, such as, K=3 represents three channels of luminance Lu, red-difference chrominance Cr, blue-difference chrominance Cb, K1+K2=K.

The picture data with specification of M*N*K, according to a split method of M*(N1+N2)*(K1+K2), can be split into four three-dimensional matrix: M*N1*K1, M*N2*K1, M*N1*K2, M*N2*K2. For example, specification of the picture data is 1000*800*3; where M=1000, N=800, K=3. N can be split as N1+N2, K can be split as K1+K2, according to the split way of M*(N1+N2)*(K1+K2), where N1=300, N2=500, K1=1, K2=2. In this way, the picture data can be split into four three-dimensional matrix: 1000*300*1, 1000*500*1, 1000*300*2, and 1000*500*2.

The further technical solution has the following beneficial effects: as storage space of local memory is limited, the further technical scheme of this invention can flexibly split the three-dimensional matrix of picture data into some small three-dimensional matrix, and adapt to the storage capacity of local memory, so as to support as many different specifications of the picture data as possible.

FIG. 2 shows a block diagram of a device for hardware acceleration of a neural network model of a first electronic equipment.

As shown in FIG. 2, a first embodiment of a device for hardware acceleration of a neural network model of a first electronic equipment comprises: an acquisition module, a convolution calculation module, and a function calculation module.

The acquisition module is used for obtaining data to be identified and a configuration parameter of the neural network model of the first electronic equipment.

The configuration parameter comprises: a weight parameter of the neural network model of the first electronic equipment, a convolution calculation parameter, and one or more of function parameters which need to be called. The weight parameter is generated by rearranging an original weight parameter of the neural network model of the first electronic equipment based on a format needed by the first electronic equipment. The convolution calculation parameter comprises: specification of the data to be identified, quantity of a convolution kernel, size of the convolution kernel, step size of the convolution calculation, and one or more of number of layers of the neural network model. Called function parameters which are required comprises: a function name, a function parameter and a calling sequence, which is called by the neural network model of the first electronic equipment according to requirement. For example, which functions need to be called after a convolution calculation is completed, if Eltwise and ReLU are required, what are parameters of Eltwise, whether to call Eltwise first, or to call ReLU first.

The convolution calculation module is used for proceeding the hardware acceleration of a convolution calculation matched with the neural network model of the first electronic equipment for the data to be identified according to the configuration parameter, and generating the convolution result of the neural network model of the first electronic equipment for the data to be identified.

In order to enable the acceleration equipment to support various convolution neural network models in the convolution calculation, specifications of pictures and specifications of convolution kernels can be set by the configuration parameter, such as, specifications of pictures for 224*224*3 and 300*300*3, specifications of convolution kernels for 3*3*3 or 7*7*3. Specifically, for the convolution calculation, specification of the picture data and convolution kernels is extracted from the convolution calculation parameter of the configuration parameter obtained in S1 to proceed the convolution calculation for the picture data.

The function calculation module, used for proceeding the hardware acceleration of a function calculation for the convolution result by calling one or more function modules which match with the neural network model of the first electronic equipment from at least one function module which preset according to the configuration parameter, and generating a recognition result of the neural network model of the first electronic equipment for the data to be identified.

In order to enable the acceleration equipment to support various convolution neural network models in the convolution calculation, multiple functions can be preset. Specifically, the convolution result is calculated by a function which is selected from multiple functions preset and adapted with the configuration parameter according to called function parameters of the configuration parameter obtained in S1, and the calculation result can be obtained.

At least one function module which preset comprises one or more of the following functions: BatchNorm, Scale, Eltwise, ReLU, Sigmoid, Tanh, Pooling, max pooling, mean pooling, root mean square pooling, FC, and Softmax. The above various functions have been described in the foregoing, and will not be described here.

Another embodiment of the device for the hardware acceleration of the neural network model of the first electronic equipment, further comprises: a read and write control module, used for reading the data to be identified and the configuration parameter of the neural network model of the first electronic equipment from an external memory, and writing the data to be identified and the configuration parameter of the neural network model of the first electronic equipment which is read into a local memory.

Further, in another embodiment of the device for the hardware acceleration of the neural network model of the first electronic equipment, the function calculation module comprises: a function skip module and at least one function module; each function module is used for implementing a function calculation of a specific function; the function skip module is used for connecting one or more function modules by Bypass according to the configuration parameter; the convolution result is inputted into one or more function modules which are connected by Bypass, proceeded by one or more function modules with hardware acceleration in order and outputted as a result.

Further, in another embodiment of the device for the hardware acceleration of the neural network model of the first electronic equipment, if specification of the data to be identified which is read by the read and write control module is M*N*K, according to a split method of M*(N1+N2)*(K1+K2), the data to be identified is split into some small three-dimensional matrix when the read and write control module is writing; for a picture file, M is a width of a picture, N is a height of the picture, K is number of channels of the picture; K1+K2=K, N1+N2=N.

Further, in another embodiment of the device for the hardware acceleration of the neural network model of the first electronic equipment, the read and write control module is used to implement that, when the data to be identified is reading and writing, each separate data file is read and written only once.

In order that the method for the hardware acceleration of the first electronic equipment can be compatible with various open source environments and a user-defined neural network model, the present provides a method for an auxiliary acceleration of a neural network model of a second electronic equipment, and comprises the following steps S01-S02:

S01, extracting a topology structure and a parameter for each layer of the neural network model of the first electronic equipment which is trained from an open source framework, and based on the topology structure and the parameter for each layer which is extracted generating the configuration parameter of the first electronic equipment which is used in the method for the hardware acceleration of the neural network model of the first electronic equipment according to any one of the foregoing claims.

S02, providing the configuration parameter to the first electronic equipment.

The second electronic equipment is preferably a host computer, and may be a computing equipment with a universal hardware structure. There are many types of open source environments, and various neural network models have different expression forms. Pre-analysis and processing of the original model can extract effective parameters more accurately, reduce the difference of models, improve the compatibility of hardware equipment, and helps accelerate the overall design in an auxiliary way. The method for the auxiliary acceleration in the embodiment of the present application is implemented by a software program, including a network topology extraction layer and a driver layer, and the software program can be run in a general-purpose computing equipment.

The network topology extraction layer generates configuration parameters and the parameters of each layer required by the acceleration equipment according to the topology structure of the trained neural network model. For example, in resnet18, after the convolution calculation is completed, the subsequent function calculations include BatchNorm, Scale, ReLU, and Pooling. The network topology extraction layer extracts the convolution calculation parameter, the weight parameter, function parameters of BatchNorm and Scale according to the topology structure of the neural network model, and generates the corresponding configuration parameter, so that the acceleration equipment proceeds the convolution calculation and the function calculation according to the configuration parameter which is set. The driver layer is used for delivering the generated configuration parameters to the specified DDR address, sending a control command to the acceleration equipment, and retrieving data result after the calculation is completed.

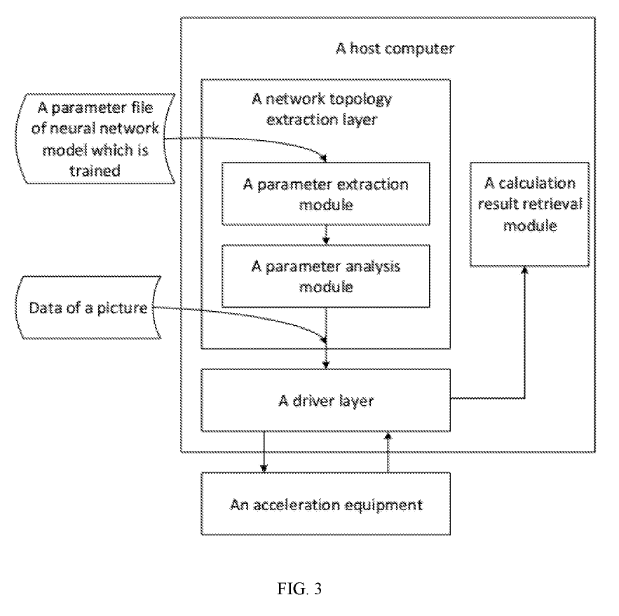

FIG. 3 shows a schematic diagram of an embodiment of the device for the hardware acceleration of the neural network model of the first electronic equipment and an auxiliary software program of a neural network model of a second electronic equipment.

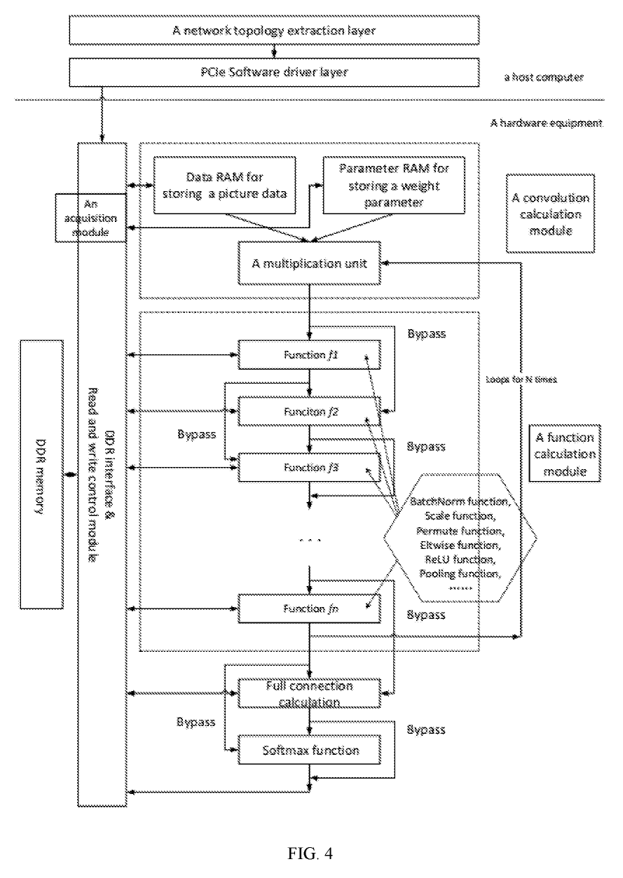

FIG. 4 shows an internal function diagram for an acceleration equipment in FIG. 3. Thereinto, as shown in FIG. 3, a software function partitioning and dependency relationship of the second electronic equipment (preferably a host computer in FIG. 3) is further described.

Optionally, the network topology extraction layer further includes a parameter extraction module and a parameter analysis module; a parameter file of a trained neural network model is extracted by the parameter extraction module, afterwards processed by the parameter analysis module, and then provided to the driver layer together with the image file; the calculation result returns to the driver layer after the hardware acceleration of the calculation of the neural network model completed by the acceleration equipment; and a ultimate output result is recorded by a calculation result retrieval module.

As shown in FIG. 4, the internal module partitioning and connection relationship between a host computer and a hardware equipment are further described.

Optionally, the host program comprises a network topology extraction layer and a driver layer. The hardware equipment is partitioned into a DDR interface, a read and write control module, a DDR memory, a convolution calculation module and a function calculation module.

Further, the convolution calculation module comprises a RAM for data, a RAM for parameter and a multiplication unit. The RAM for data is used for storing a picture data read from DDR by the acquisition module, and the RAM for parameter is used for storing the configuration parameter from DDR by the acquisition module. The picture data and the configuration parameter is provided to the multiplication unit for proceeding the hardware acceleration of the convolution calculation. The function calculation module comprises n function modules, named as f1,f2,f3 . . . fn, each of which may be one of the function modules: BatchNorm, Scale, Eltwise, ReLU, Pooling, and so on.

the function calculation modules including n function modules, full connection calculation modules, and Softmax modules are connected by Bypass, the hardware acceleration required for the calculation of the neural network model is proceeded according to the configuration parameter, and the result is returned to the DDR memory.

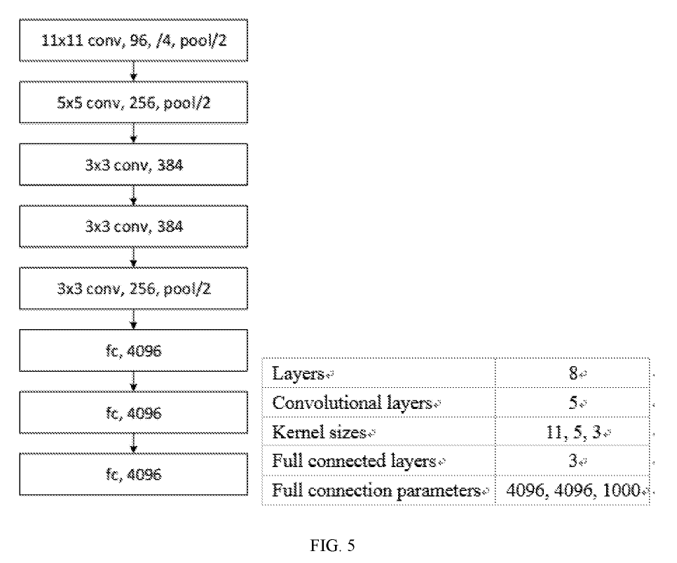

The following takes AlexNet as an example in FIG. 5 to describe the device of hardware acceleration for the neural network model of the first electronic equipment and an auxiliary software program for a neural network model of a second electronic equipment provided by this invention.

At present, there are many open source frameworks for deep learning, such as Tensorflow, Torch, Caffe, Theano, Mxnet, Keras, etc. This example is based on frameworks of Caffe/Tensorflow, but it is not limited to these frameworks.

1. Parameter Extraction

After the neural network model is trained, the corresponding parameter file of the neural network model is generated. In this embodiment, the topology structure of the neural network model and the parameters of each layer are extracted from the parameter file of the neural network model by using the auxiliary software program for the neural network model of the second electronic equipment running on the host computer, and the configuration parameter is generated based on the extracted neural network model topology structure and parameter.

As shown in FIG. 5, AlexNet comprises eight layers, so there are parameters of 8 layers that need to be extracted. A parameter to be extracted comprises: a weight parameter, a convolution parameter, one or more of called function parameters which are required. The weight parameter is weight value of 11*11*3*96 convolution kernels. The convolution calculation parameter comprises: the number of channels of the image to be predicted (in the embodiment of FIG. 5 is 3), the size of the convolution kernel (in the embodiment of FIG. 5 is 11×11), and the number of channels of the convolution kernel (In the embodiment of FIG. 5 is 96), step size of the convolution calculation (in the embodiment of FIG. 5 is 4). Called function parameters which are required comprise ReLU and Pooling.

2. Parameter Analysis

The parameters and configurations obtained from the previous step are rearranged according to a format set by the first equipment, and the configuration parameter is obtained.

The format set by the first equipment comprises: an order of each parameter, a storage address, a numerical precision, and so on. For example, an order of the convolution calculation parameter is the number of channels of the image to be predicted, a length of the convolution kernel, a width of the convolution kernel, and step size of the convolution kernel. The weight parameter is stored from DDR address 0x200, the precision of an image data is float, and the precision of a convolution kernel weight parameter is short.

3. Parameter Delivery

The picture data and the configuration parameter are sent to the first electronic equipment (hardware acceleration equipment) through the driver layer, and the calculation is started to get the calculation result.

The driver layer delivers the configuration parameter to the DDR. A DDR region is divided into multiple functional regions, each of which can flexibly stores the convolution parameter or the calculation result, and the driver layer stores the configuration parameter in a specified divided region.

After obtaining the picture data and the configuration parameter of the neural network model, the convolution calculation is proceeded for the picture data according to the configuration parameter to get the convolution result. The function calculation for the convolution result by calling one or more functions which match with the neural network model of the first electronic equipment from at least one function which preset is proceeded according to the configuration parameter, the calculation result is generated and returned to the calculation result retrieval module of the host computer.

The first electronic equipment (hardware acceleration equipment) in the embodiment of the present application includes a hardware circuit design of a universal convolution calculation module and various function calculation modules to provide hardware acceleration capability for the convolution calculation and the corresponding function calculation. When the algorithm of the neural network model is updated, or a different neural network model is used, only the parameter of the first electronic equipment needs to be reconfigured without changing the hardware design. That is, there is no need to change an underlying circuit design of a hardware accelerator, and only need to generate the corresponding configuration parameter according to the topology structure of the convolution neural network and parameters of each layer, so that the hardware acceleration of corresponding network models can be obtained. The invention adopts a universal scheme to support the hardware acceleration of various convolution networks, thereby eliminating the redesign of the hardware acceleration, and supporting users to modify and quickly iterate the algorithm, which greatly facilitates the users to use.

This invention can not only implement the hardware acceleration of open source models, such as LeNet, AlexNet, GoogLeNet, VGG, ResNet, SSD, etc., but also support for implementing non-generic models, like network models combined by Resnet18 and SSD300.

This invention can be used not only for FPGA design, but also for ASIC design. As a universal circuit is adopted, various convolution neural networks can be supported, and it is feasible to instantiate it in an FPGA design or an ASIC design.

The above-mentioned specific embodiments of the present invention are only used to illustrate or explain the principles of the present invention, and do not constitute a limitation to the invention. Therefore, any modifications, equivalent substitutions, improvements, etc., which are made without departing from the spirit and scope of the invention, shall be included in the scope of protection of the present invention. In addition, the claims appended to the present invention are intended to cover all changes and modifications that fall within the scope and boundary of the appended claims or the equivalent form of such scope and boundary, that should be understood.

The above illustrates and describes basic principles, main features and advantages of the present invention. Those skilled in the art should appreciate that the above embodiments do not limit the present invention in any form. Technical solutions obtained by equivalent substitution or equivalent variations all fall within the scope of the present invention.

1. A method for hardware acceleration of a neural network model of a first electronic equipment, comprising:
obtaining data to be identified and a configuration parameter for the neural network model of the first electronic equipment;
proceeding the hardware acceleration of a convolution calculation matched with the neural network model of the first electronic equipment for the data to be identified according to the configuration parameter, and generating a convolution result of the neural network model of the first electronic equipment for the data to be identified; and
proceeding the hardware acceleration of a function calculation for the convolution result by calling one or more function modules which match with the neural network model of the first electronic equipment from at least one function module which preset according to the configuration parameter, and generating a recognition result of the neural network model of the first electronic equipment for the data to be identified.

2. The method of claim 1, wherein the configuration parameter comprises:
a weight parameter of the neural network model of the first electronic equipment, a convolution calculation parameter, and one or more of called function parameters which are required;
wherein the weight parameter is generated by rearranging an original weight parameter of the neural network model of the first electronic equipment based on a format needed by the first electronic equipment;
the convolution calculation parameter comprises: specification of the data to be identified, quantity of a convolution kernel, size of the convolution kernel, step size of the convolution calculation, and one or more of number of layers of the neural network model;
called function parameters which are required comprise: a function name, a function parameter and a calling sequence, which is called by the neural network model of the first electronic equipment according to requirement.

3. The method of claim 1, wherein the hardware acceleration of the function calculation for the convolution result comprises:
connecting one or more function modules by Bypass according to the configuration parameter; and
inputting the convolution result into one or more function modules which are connected by Bypass, proceeding the hardware acceleration by one or more function modules in order and outputting a result.

4. The method of claim 1, wherein at least one function module which preset comprises one or more of the following functions: BatchNorm, Scale, Eltwise, ReLU, Sigmoid, Tanh, Pooling, max pooling, mean pooling, root mean square pooling, FC, and Softmax.

5. The method of claim 1, wherein the data to be identified and the configuration parameter of the neural network model of the first electronic equipment comprises: reading the data to be identified and the configuration parameter of the neural network model of the first electronic equipment from an external memory, and writing the data to be identified and the configuration parameter of the neural network model of the first electronic equipment which is read into a local memory.

6. The method of claim 5, wherein when the data to be identified is reading and writing, each separate data file is read and written only once.

7. The method of claim 5, wherein if specification of the data to be identified which is read is M*N*K, according to a split method of M*(N1+N2)*(K1+K2) the processing data is split into some small three-dimensional matrix at the time of writing when the data to be identified is writing;
for a picture file, M is a width of a picture, N is a height of the picture, K is number of channels of the picture; K1+K2=K, N1+N2=N.

8. A device for hardware acceleration of a neural network model of a first electronic equipment, comprising:
an acquisition module, used for obtaining data to be identified and a configuration parameter of the neural network model of the first electronic equipment;
a convolution calculation module, used for proceeding the hardware acceleration of a convolution calculation matched with the neural network model of the first electronic equipment for the data to be identified according to the configuration parameter, and generating a convolution result of the neural network model of the first electronic equipment for the data to be identified; and
a function calculation module, used for proceeding the hardware acceleration of a function calculation for the convolution result by calling one or more function modules which match with the neural network model of the first electronic equipment from at least one function module which preset according to the configuration parameter, and generating a recognition result of the neural network model of the first electronic equipment for the data to be identified.

9. The device of claim 8, wherein the configuration parameter comprises:
a weight parameter of the neural network model of the first electronic equipment, a convolution calculation parameter, and one or more of function parameters which need to be called;
wherein the weight parameter is generated by rearranging an original weight parameter of the neural network model of the first electronic equipment based on a format needed by the first electronic equipment;
the convolution calculation parameter comprises: specification of the data to be identified, quantity of a convolution kernel, size of the convolution kernel, step size of the convolution calculation, and one or more of number of layers of the neural network model;
function parameters called which are required comprises: a function name, a function parameter and a calling sequence, which is called by the neural network model of the first electronic equipment according to requirement.

10. The device of claim 8 or claim 9, wherein the function calculation module comprises:
a function skip module and at least one function module;
wherein each function module is used for implementing a function calculation of a specific function;
the function skip module is used for connecting one or more function modules by Bypass according to the configuration parameter; the convolution result is inputted into one or more function modules which are connected by Bypass, proceeded by one or more function modules with hardware acceleration in order and outputted as a result.

11. The device of claim 8 or claim 9, wherein at least one function module which preset comprises one or more of the following functions: BatchNorm, Scale, Eltwise, ReLU, Sigmoid, or Tanh, Pooling, max pooling, mean pooling, root mean square pooling, FC, and Softmax.

12. The device of claim 8 or claim 9, further comprising: a read and write control module, used for reading the data to be identified and the configuration parameter of the neural network model of the first electronic equipment from an external memory, and writing the data to be identified and the configuration parameter of the neural network model of the first electronic equipment which is read into a local memory.

13. The device of claim 12, wherein the read and write control module is used to implement that, when the data to be identified is reading and writing, each separate data file is read and written only once.

14. The device of claim 12, wherein if specification of the data to be identified which is read by the read and write control module is M*N*K, according to a split method of M*(N1+N2)*(K1+K2) the data to be identified is split into some small three-dimensional matrix when the read and write control module is writing;
for a picture file, M is a width of a picture, N is a height of the picture, K is number of channels of the picture; K1+K2=K, N1+N2=N.

15. A method for an auxiliary acceleration of a neural network model of a second electronic equipment, comprising:
extracting a topology structure and a parameter for each layer of the neural network model of the first electronic equipment which is trained from an open source framework, and based on the topology structure and the parameter for each layer which is extracted, generating the configuration parameter of the first electronic equipment which is used in the method for the hardware acceleration of the neural network model of the first electronic equipment according to claim 1; and
providing the configuration parameter to the first electronic equipment.
